(19) United States
(12) Patent Application Publication
(10) Pub. No.: US 2019/0266234 A1
(43) Pub. Date: Aug. 29, 2019

(54) NEURAL NETWORK LEARNING ENGINE

(71) Applicant: AMERICAN INSTITUTES FOR RESEARCH, Washington, DC (US)

(72) Inventor: Christopher M. Ormerod, Falls Church, VA (US)

(73) Assignee: AMERICAN INSTITUTES FOR RESEARCH, WASHINGTON, MA (US)

(21) Appl. No.: 16/286,566

(22) Filed: Feb. 26, 2019

Related U.S. Application Data
(60) Provisional application No. 62/636,044, filed on Feb. 27, 2018.

(51) Int. Cl. G06F 17/27; G06N 3/04; G06N 3/08; G06N 20/10

(52) U.S. Cl. CPC G06F 17/273; G06N 20/10; G06N 3/08; G06N 3/0445

(57) ABSTRACT

A neural network for assertion-based scoring can include a support vector classifier and a plurality of sequential layers. The sequential layers can include, for example, a word embedding layer, a conventional layer, a recurrent layer, a dense layer, and/or a dropout layer. The neural network can be configured to perform a word-frequency count and/or can be configured to collect candidate words of various Levenshtein distances from standard-spelling variations.

### PRIORITY CLAIM

The application claims priority from U.S. Provisional Patent Application No. 62/636,044, filed Feb. 27, 2018, which is incorporated by reference in its entirety.

### TECHNICAL FIELD

The present invention relates generally to a system, engine, and method for improving machine learning in artificial neural networks, and specifically to expanding the vocabulary understood by a neural network.

### BACKGROUND

Artificial neural networks typically include large numbers of interconnected processing elements called neurons. A neuron is typically designed to receive inputs that set or change its internal state according to the input, a process called activation. Neurons can produce output based on the input and activation. Neural networks can employ machine learning or be configured to learn by example. For example, a neural network can learn to recognize patterns, classify data, devise complex models, and create new algorithms.

Spell-checking algorithms attempt to replace misspelled words with their correctly spelled versions. Such algorithms typically correct words up to, at most, a Levenshtein distance of 3 from a correctly spelled word. Broadly, the Levenshtein distance between two words (or strings of letters) is the number of single-character deletions, insertions, or substitutions required to change one word into the other.

### SUMMARY

An aspect can include a neural network for assertion-based scoring. The neural network can include a support vector classifier and a plurality of sequential layers. The sequential layers can include, for example, a word embedding layer, a conventional layer, a recurrent layer, a dense layer, and/or a dropout layer.

In some embodiments, the word embedding layer can be configured to perform word embedding. The word embedding can be a single component of a larger neural network.

In another aspect, the plurality of sequential layers include a word embedding layer, a first convolutional layer, a second convolutional layer, a recurrent layer, and/or a plurality of dense layers. The recurrent layer can form a component of the scoring engine.

In some embodiments, the recurrent layer can utilize gated-recurrent-units. In other embodiments, the recurrent layer can utilize a simple recurrent neural network, a long-short-term-memory network, and/or a neural architecture search.

In certain embodiments, the plurality of dense layers can utilize filters. The filters can be of various sizes, including, e.g., size 256, 64, and/or 16.

An aspect of a neural network for assertion-based scoring can include a support vector classifier and a plurality of sequential layers, wherein the neural network cam be configured to perform scoring, and the scoring can be short answer scoring.

Another aspect of a neural network for assertion-based scoring can include a support vector classifier and a plurality of sequential layers, wherein the neural network can be configured to perform a word count on a text. Each word can have a frequency in the text. The neural network can be configured to store the frequency of each word.

In some embodiments, the frequency of each word can be normalized to generate a normalized frequency of each word.

In other embodiments, the neural network can be configured to calculate a weight, w, for each word according to the equation: w=log((i+1) log(length of the word)), where the integer i is the order in the vocabulary. This can be ordered by listing the most frequent words first.

Another aspect of a neural network for assertion-based scoring can include a support vector classifier and a plurality of sequential layers, wherein the neural network can be configured to determine whether a word in a training set is included in an embedding. The neural network can be configured to identify misspelled words from the text. The neural network can also include a spell-correction engine and/or a word embedding. A word embedding can include standard-spelling variations.

Embodiments of a neural network can be configured to collect a first set of candidates. The first set can include all words from the text that are of Levenshtein distance 1 from standard-spelling variations. The neural network can be configured to return the word having the highest frequency in the text if the first set of candidates is not empty. The neural network is configured to collect a second set of candidates if the first set of candidates is empty. A second set can include all words from the text that are of Levenshtein distance 2 from standard-spelling variations. The neural network can be configured to return the word having the highest frequency in the text if the second set of candidates is not empty. The neural network can be configured to partition inputs into words that minimize the sum of the word weights if the second set of candidates is empty.

In some embodiments, the word can a Levenshtein distance of between 1 and 5 from a standard-spelling variation, and the neural network can be configured to search the word of Levenshtein distance of between 1 and 5. For example, the word can be a Levenshtein distance of 3 from a standard-spelling variation. The neural network can be configured to search the word of Levenshtein distance of 3. The word can be a Levenshtein distance of 4 from a standard-spelling variation. The neural network can be configured to search the word of Levenshtein distance of 4. The word can be a Levenshtein distance of 5 from a standard-spelling variation. The neural network can be configured to search the word of Levenshtein distance of 5.

### DESCRIPTION OF THE DRAWINGS

Illustrative embodiments of the present invention are described in detail below with reference to the attached drawing figures, which are incorporated by reference herein and wherein:

FIG. 1 illustrates a vocabulary expansion process for improving machine learning.

FIG. 2 illustrates a neural network.

FIG. 3 illustrates layers of a neural network.

### DETAILED DESCRIPTION OF EXEMPLARY EMBODIMENTS

A detailed explanation of the system and method according to exemplary embodiments of the present invention are described below. Exemplary embodiments described, shown, and/or disclosed herein are not intended to limit the claims, but rather, are intended to instruct one of ordinary skill in the art as to various aspects of the invention. Other embodiments can be practiced and/or implemented without departing from the scope and spirit of the claimed invention.

As one skilled in the art will appreciate, embodiments of the present invention may be embodied as, among other things: a method, system, or computer-program product. Accordingly, the embodiments may take the form of a hardware embodiment, a software embodiment, or an embodiment combining software and hardware. In one embodiment, the present invention takes the form of a computer-program product that includes computer-useable instructions embodied on one or more computer-readable media.

Embodiments herein can be advantageous for scoring engines, for example as used to score student responses. Aspects can enhance preprocessing as well as the design and function of a neural network. As will be appreciated by a person of ordinary skill, preprocessing can utilize known components, such as Python standard libraries, Google and GloVe Word Embeddings, Peter Norvig algorithms, a corpus or corpora of student responses, and/or other components described herein.

Aspects of the invention can be particularly advantageous where the machine learning engine is a neural network or an ensemble of neural networks. Input to the neural network can be preprocessed to increase the performance of the neural network.

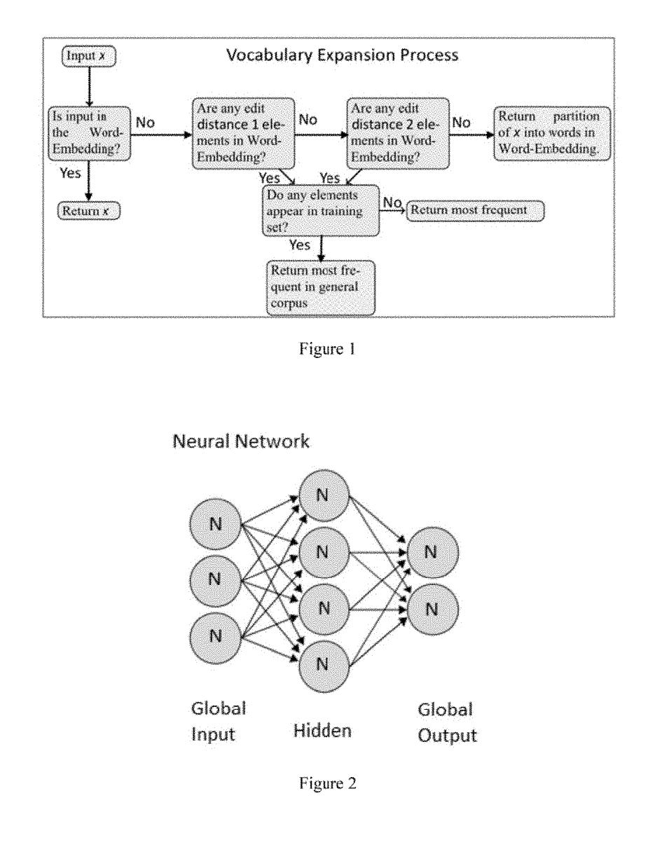

FIG. 1 depicts an example of input preprocessing for vocabulary expansion. The preprocessing can utilize a spell checking-type algorithm to expand the training set to include frequently misspelled words and, for those words, their most frequent forms of misspelling. These words can then be added to the neural net training set to train the net to accept and recognize those words.

Historically, spell-checking algorithms have often attempted to replace a given misspelled word with a correct one. Such algorithms overlook that misspelled words can acquire meaning to machine learning systems. Present embodiments, however, can replace or break down a word into components that are understandable by a word embedding. While the Norvigs algorithm has been used to correct text, it is most commonly used to correct words up to a Levenshtein distance of up to at most 3 from a correctly spelled word. The memory required to search words of greater Levenshtein distance from a vocabulary grows exponentially with the distance considered, which is why most implementations only consider at most Levenshtein distance 3 corrections.

The preprocessing can rely on word embedding used for input to the neural network. Some embodiments can represent each word that the neural network will see by a word that is at most a Levenshtein distance of 2 from elements in the word embedding with a first preference for the most frequently used word in the training set, and a second preference to the word most commonly used by the student population. If no word of Levenshtein distance of 2 is found, the word can be broken up into words that do appear in the embedding. Here, the Levenshtein distance of 2 is merely an example, as present embodiments can exploit Levenshtein distances at least an order of magnitude greater than 2.

Enlarging the vocabulary of a neural network can be advantageous. Word embeddings, whether trained on a large corpus of student responses or pre-trained on large corpora of text, can be defined for common misspellings of words. Misspellings, by their usage, possess a strong cosine-similarity with their correctly spelled versions, yet they can have a high Levenshtein distance from their correctly spelled variants. By searching and replacing words that are not in an embedding with those in the embedding that are up to a preferred Levenshtein distance away, words are not corrected in the sense that traditional spell-checking algorithms do. Nevertheless, a neural network with a word-embedding layer can be enabled to understand words that are of a Levenshtein distance far greater from a correctly spelled word than spell-checking algorithms allow. Failing an element of a preferred Levenshtein distance, the algorithm can decompose the word into words in the embedding. Accordingly, present neural networks can be much more tolerant to spelling-mistakes than those utilizing other approaches. For example, utilizing one enlarged vocabulary embodiment, ten prototype items were analyzed for three question responses and compared to analysis utilizing traditional spell correction. The neural network's increased tolerance gained from vocabulary enlarging over spell-checking was estimated to account for a positive increase in quadratic weighted kappa (QWK) by approximately eight percent.

Referring again to the embodiment of FIG. 1, for each embedding used, the preprocessor can perform a word count on a large corpus of approximately 40 million student responses. Those responses can be contained in a general student corpus. For each word in the word embedding, the preprocessor can store the frequency that the word appears in the general student corpus. That frequency can be normalized to a real number between 0 and 1. The preprocessor can perform a word count of all the words that appear in a set of training responses. The preprocessor can also append those results to the dictionary as integers. Accordingly, for any word in the embedding, the dictionary can contain an integer, if the word appears in the training set, or a number between 0 and 1, representing an approximate frequency that the word appears in use by the population. The dictionary is herein referred to as the training frequency counter.

For each word that appears in the embedding, the weight, w, of that word can be calculated by:

w=log{(i+1)log(length of the word)}

where the integer i refers to the word's order in the vocabulary, which is ordered by listing the most frequent words first. The weight can be based on the assumption that the frequency of words follows Zipf's law. For each training item, the preprocessor can split the text into words and punctuation. Every word can be checked to see whether it appears in the word embedding. If a word in the training set does not appear in the embedding, it can be considered to be incorrectly spelled. Once a word is identified as being incorrectly spelled, it can be passed to the spell-correction engine before being used to train the neural network. The same preprocessing is performed for every element that is sent to the scoring engine for scoring.

In some embodiments, the preprocessing vocabulary expansion can improve neural network tolerance for words not found in the word embedding as follows. A complete set of first candidates can be collected. The set of first candidates can be words that are of Levenshtein distance 1 from the input that appears in the word embedding. If the set of first candidates is not empty, words with the highest values in the training frequency counter can be returned. If the set of first candidates is empty, a complete set of second candidates can be collected. The set of second candidates can be words that have a Levenshtein distance 2 from the input that appears in the word embedding. If the set of second candidates is not empty, words with the highest values in the training frequency counter can be returned. If the set of second candidates is empty, the input into words that minimizes the sum of the word weights involved can be partitioned. A minimum is therefore guaranteed where the letters in the alphabet appear in the word embedding. Thus, unlike a spell checker that uses the found misspelling to produce the correctly spelled word, the invention can utilize the found misspelling to expand the vocabulary recognized by the neural net and make it more tolerant of the less than perfect spelling from the student.

Preprocessing embodiments here can be specific to word embedding used as opposed to a general large corpus. As such, they have several advantages. For example, the ordering used to choose a word can be tuned by a large corpus of student responses, or other database of text. Further, by partitioning the input into words once the second set of candidates is found, a class of misspelled words can be predicted or identified.

Turning to specific aspects of the neural network, embodiments herein can be applied to assertions of a piece of text. The application of neural networks to assertion-based scoring is not previously known. In certain embodiments, the neural network has been carefully designed to perform well for the task of short answer scoring.

FIG. 2 conceptually illustrates a neural network. As shown, the network can receive global input and produce global output. The number of interconnected neurons (N) can receive inputs and can produce outputs. As will be appreciated by a person having ordinary skill in the art, the numbers of neurons in present networks are much higher. For example, a single processing core of the network can include more than a million neurons.

Neural networks described herein can be designed utilizing, for example, Python standard libraries, Google and GloVe Word-Embedding, Keras API, and/or other components as will be appreciated by a person of skill in the art. After the preprocessing, the text input into the neural network can be a collection of numbers. Each number can represent a word. The output of the neural network can be a decimal number, for example between 0 and 1. That decimal number can be representative of the confidence that the text input satisfies the binary assertion. The effectiveness of binary classifiers can be utilized by reducing the scoring to delivering binary assertions. The combination with assertions can provide a more detailed assessment of student performance. This can provide greater insights into strengths and deficiencies than a single score.

Certain designs of the neural network can be characterized as sequential models. The neural network can include one or more layers, such as word embedding layers, conventional layers, recurrent layers, dense layers, dropout layers. In some embodiments, each of those layers can be employed sequentially. In other embodiments, one or more, but not all, of the layers can be utilized. In yet other embodiments, certain layers can be utilized in parallel, such as through parallel processing in cooperation with or separate from neurons of the neural network.

Word Embedding Layer Proprietary and/or commercial word embedding can be utilized. By way of example for a person of ordinary skill and not to limit the invention to any one embodiment, commercial word embedding tools can include Google News word embedding, which has been trained on an extensive corpus of news items, and/or GloVe word embedding, which has been trained on a common crawl. Both are 300-dimensional word embeddings, and both claim to be of a very high accuracy. Those word embedding tools can turn a text, of a maximal word length of 300, into a 300 by 300 tensor. The output tensor can be utilized as input for other layers of the neural network. A final score can be an aggregate of scores from two or more word embedding tools. Other word embedding can utilize a maximal word length less than or greater than 300. Similarly, tensors of different sizes can be utilized, as preferred to optimize processing time or system efficiency.

Convolutional Layer: Alter the word embedding, each word can be stored as a 300-dimensional vector that captures semantic information. Relevant semantic information can change when combinations of words are considered, for example “nervous system” and “computer program.” A given word may not be in the word embedding. However, when broken up into pieces, the word embedding can understand the word, such as specific names. The text can pass through a double-stacked convolutional layer. For example, the convolution can be implemented to look within five terms, so that phrases of a span of nine words relevant to the scoring can be picked up.

Recurrent Layer: Recurrent layers can form a component of the scoring engine. The layers can include semantic comprehension. Choices for base units are abundant, for example: simple recurrent neural network (RNN), long-short-term-memory (LSTM) network, gated-recurrent-units (GRU), neural architecture search (NAS), etc. By way of non-limiting example, GRU can be utilized, which can be efficient and efficacious. A single layer of GRU-units with 128 filters can be utilized. The filters can pick up possibly long-term patterns in the sequences which span beyond the convolutional layer.

Dense Layer: The filters of the RNN can pick up all components of the score, which after filtering can be embedded in thousands of filters. The information can be grouped into dense layers of various sizes. For example, they can be grouped into four dense layers of size 256, 64, 16 and 1 respectively. Grouping can help ensure that sufficiently many possible combinations of filters contribute to the final score.

Dropout Layer: Between each layer, an aggressive dropout layer can be employed. These layers can remove a random selection of, e.g., approximately half the connections between neurons in any one training cycle. As this is a particularly deep network to account for any complexing scoring rubric, this can be employed to aggressively protect the neural network from overfitting.

With a deep network, choosing an appropriate loss function and/or optimizer can help ensure the network yields sensible results. Based on experimentation with various loss functions—such as sum of squares due to error (SSE), log SSE, binary-cross-entropy—as well as various optimizers—such as adaptive moment estimation (ADAM), adaptive learning rate (ADADELTA), stochastic gradient descent (SGD), and RMSPROP—the combination of a balanced weighted binary-cross-entropy and the RMSprop optimizer with backpropagation were found particularly useful and appropriately converged. For example, the system converged in between 1000 and 3000 training epochs. A standard training time of 3000 epochs was an acceptable option.

The final output of the system can have a nonlinear nature. The scores of an essay can be fed into a support vector classifier. The kernel of the classifier may change in accordance with the observed nature of the scores outputted by the neural networks involved.

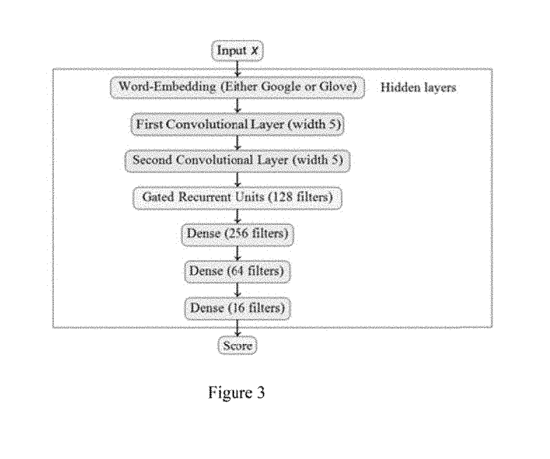

FIG. 3 illustrates an exemplary sequential model for a neural network. The network can receive an input “x” and generate an output score. The embodiment includes various hidden layers, including word embedding, first and second convolutional layers, a recurrent layer that utilizes gated-recurrent-units, and three dense layers that utilize filters of size 256, 64, 16.

Some embodiments can utilize a support vector classifier, as opposed to a logistic regression, as the final output has the interpretation of a larger neural network. In some embodiments, the design of FIG. 3 for different word-embeddings can be one component of this larger neural network.

Computer-readable media include both volatile and nonvolatile media, removable and non-removable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic mediator other optical disc storage, magnetic cassettes, magnetic tape, magnetic disk storage, and other magnetic storage devices. These memory components can store data momentarily, temporarily, or permanently.

All of the systems and methods disclosed herein can be made and executed without undue experimentation in light of the present disclosure. While the apparatus and methods of this invention have been described in terms of preferred embodiments, it will be apparent to those of skill in the art that variations may be applied to the methods and in the steps or in the sequence of steps of the method described herein without departing from the concept, spirit and scope or the invention. In addition, from the foregoing it will be seen that this invention is one well adapted to attain all the ends and objects set forth above, together with other advantages. It will be understood that certain features and sub-combinations are of utility and may be employed without reference to other features and sub-combinations. This is contemplated and within the scope of the invention. All such similar substitutes and modifications apparent to those skilled in the art are deemed to be within the spirit and scope of the invention. Embodiments and aspects can take various forms, for example as discussed in the following claims.

I claim:

1. A neural network for assertion-based scoring, comprising:
a support vector classifier; and
a plurality of sequential layers, wherein the plurality of sequential layers include a word embedding layer, a conventional layer, a recurrent layer, a dense layer, and a dropout layer.

2. The neural network of claim 1, wherein the word embedding layer is configured to perform word embedding.

3. The neural network of claim 2, wherein word embedding is a single component of a larger neural network.

4. A neural network for assertion-based scoring, comprising:
a support vector classifier;
a plurality of sequential layers, wherein the plurality of sequential layers include a word embedding layer, a first convolutional layer, a second convolutional layer, a recurrent layer, and a plurality of dense layers; and
wherein the recurrent layer forms a component of the scoring engine.

5. The neural network of claim 4, wherein the recurrent layer utilizes gated-recurrent-units.

6. The neural network of claim 4, wherein the recurrent layer utilizes a simple recurrent neural network.

7. The neural network of claim 4, wherein the recurrent layer utilizes a long-short-term-memory network.

8. The neural network of claim 4, wherein the recurrent layer utilizes a neural architecture search.

9. The neural network of claim 4, wherein the plurality of dense layers utilizes filters.

10. The neural network of claim 9, wherein the filters are of size 256, 64, and 16.

11. A neural network for assertion-based scoring, comprising:
a support vector classifier; and
a plurality of sequential layers, wherein the neural network is configured to perform scoring, and wherein the scoring is short answer scoring.

12. A neural network for assertion-based scoring, comprising:
a support vector classifier;
a plurality of sequential layers, wherein the neural network is configured to perform a word count on a text, wherein each word has a frequency in the text; and
wherein the neural network is configured to store the frequency of each word.

13. The neural network of claim 12, wherein the frequency of each word is normalized to generate a normalized frequency of each word.

14. The neural network of claim 12, wherein the neural network is further configured to calculate a weight, w, for each word according to the equation:
w=log((i+1)log(length of the word)),
where the integer i is the order in the vocabulary, which is ordered by listing the most frequent words first.

15. A neural network for assertion-based scoring, comprising:
a support vector classifier;
a plurality of sequential layers, wherein the neural network is configured to determine whether a word in a training set is included in an embedding;
wherein the neural network is configured to identify misspelled words from the text; and wherein the neural network further comprises a spell-correction engine and a word embedding, wherein the word embedding includes standard-spelling variations.

16. The neural network of claim 15, wherein the neural network is configured to collect a first set of candidates, wherein the first set includes all words from the text that are of Levenshtein distance 1 from the standard-spelling variations.

17. The neural network of claim 16, wherein if the first set of candidates is not empty, the neural network is configured to return the word having the highest frequency in the text.

18. The neural network of claim 17, wherein if the first set of candidates is empty, the neural network is configured to collect a second set of candidates, wherein the second set includes all words from the text that are of Levenshtein distance 2 from the standard-spelling variations.

19. The neural network of claim 18, wherein if the second set of candidates is not empty, the neural network is configured to return the word having the highest frequency in the text.

20. The neural network of claim 19, wherein if the second set of candidates is empty, the neural network is configured to partition inputs into words that minimize the sum of the word weights.

21. The neural network of claim 15, wherein the word is a Levenshtein distance of 3 from a standard-spelling variation, and the neural network is configured to search the word of Levenshtein distance of 3.

22. The neural network of claim 15, wherein the word is a Levenshtein distance of 4 from a standard-spelling variation, and the neural network is configured to search the word of Levenshtein distance of 4.

23. The neural network of claim 15, wherein the word is a Levenshtein distance of 5 from a standard-spelling variation, and the neural network is configured to search the word of Levenshtein distance of 5.

24. The neural network of claim 15, wherein the word is a Levenshtein distance of between 1 and 5 from a standard-spelling variation, and the neural network is configured to search the word of Levenshtein distance of between 1 and 5.
